(19) United States
(12) Patent Application Publication
(10) Pub. No.: US 2010/0317220 A1
(43) Pub. Date: Dec. 16, 2010

(54) ELECTRICAL CONNECTOR HAVING GROUNDING DEVICE

(75) Inventor: GUO-JIAN SHEN, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/813,521

(22) Filed: Jun. 11, 2010

(30) Foreign Application Priority Data
Jun. 11, 2009 (CN) 200920304296.0

(51) Int. Cl. H01R 13/64; H01R 13/648

(52) U.S. Cl. 439/374; 439/607.01

(57) ABSTRACT

An electrical connector (100a) includes an insulative housing (1) defining an engaging portion (11) extending from a base portion (10) thereof, a plurality of terminals (2) disposed in the housing (1) and having a contacting portion (20) arranged on the engaging portion (11) and a shell (3) covering an outside of the insulative housing (1). The shell (3) includes at least one forniciform-shaped grounding arm (32) which integrally extends from a first side (11b) of the engaging portion (11) forwardly and is continually folded backwards to a second side (11a) of the engaging portion (11) opposite to the first side (11b).

### BACKGROUND OF THE INVENTION

1. Field of the Invention

The present invention relates to an electrical connector, and more particularly to an electrical connector with a grounding device integrally formed by a shell of the connector.

2. Description of the Related Art

TW Pat. No. M350134 issued to Wang et al. on Feb. 1, 2009, discloses a conventional cable connector connecting with a flexible flat circuit board for transmitting signal to a mating connector. The cable connector includes an insulative housing, a plurality of terminals retained in the insulative housing, an outer shell covering outside of the insulative housing and the flexible flat circuit board engaging with a tail of the terminal. The insulative housing has a flat body portion and a plurality of terminal receiving grooves formed therein for receiving the terminal respectively. The terminals are disposed on an upper side of the insulative housing.

The outer shell includes a first shell covering a bottom side of the insulative housing opposite to the upper side thereof and a second shell covering the upper side of the insulative housing and engaging with the first shell. The first shell defines a covering portion at a front portion thereof for shielding the flat body portion of the insulative housing and a pair of grounding tails at a rear edge thereof for engaging with a pair of grounding conductors on the flexible flat circuit board. The second shell forms a pair of spring arms at a rear edge thereof for pressing against a shielding layer formed on out surface of the flexible flat circuit board. When the mating connector engages with the electrical connector, the covering portion electrically connects with the mating connector, thereby the first shell and the second shell form a grounding structure for preventing the pair connector from EMI (electronic magnetic interference).

When the pair connector engages with each other, a front edge of the grounding portion will be touched firstly by the mating connector. However, the grounding portion could be removed by the mating connector and deformed. So the grounding structure will be destroyed easily.

Therefore, an improved electrical connector is desired to overcome the disadvantages of the related arts.

### SUMMARY OF THE INVENTION

An object of the present invention is to provide an electrical connector overcoming disadvantage of the grounding structure of cable connector being easily and accidentally destroyed by the mating connector.

In order to achieve the above-mentioned object, an electrical connector in accordance with a preferred embodiment of the present invention includes an insulative housing defining an engaging portion extending from a base portion thereof, a plurality of terminals disposed in the housing and having a contacting portion arranged on the engaging portion and a shell covering an outside of the insulative housing. The shell includes at least one forniciform-shaped grounding arm which integrally extends from a first side of the engaging portion forwardly and is continually folded backwards to a second side of the engaging portion opposite to the first side.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly in accordance with the preferred embodiment of the present invention;

FIG. 2 is a perspective view of an electrical connector and an array of cables disengaged with electrical connector of FIG. 1;

FIG. 3 is an exploded perspective view of the electrical connector of FIG. 1;

FIG. 4 is a cross-section view of the electrical connector assembly taken along line 4-4 of FIG. 1;

FIG. 5 is a cross-section view of the electrical connector taken along line 5-5 of FIG. 2;

FIG. 6 is a perspective view of an electrical connector assembly and a mating connector disengaged with the electrical connector assembly of FIG. 1;

FIG. 7 is a cross-section view of the electrical connector assembly engaging with the mating connector taken along line 7-7 of FIG. 6 but without showing the cable unit; and

FIG. 8 is another cross-section view of the electrical connector assembly engaging with the mating connector taken along line 8-8 of FIG. 6 but without showing the cable unit.

### DETAILED DESCRIPTION OF THE INVENTION

Reference will now be made to the drawing figures to describe the preferred embodiment of the present invention in detail.

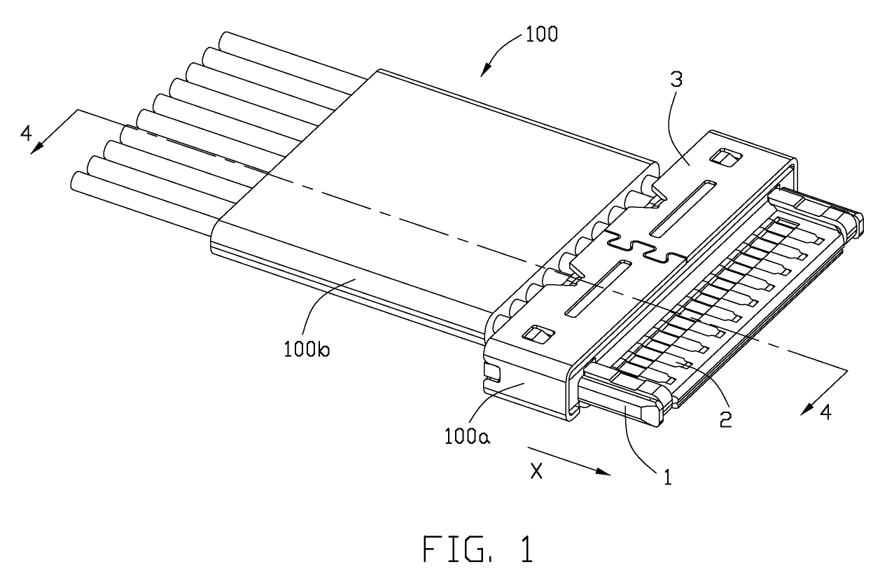

Referring to FIGS. 1 to 3, an electrical connector assembly 100 includes an electrical connector 100a and a cable unit 100b for electrically connecting with the electrical connector 100a. The electrical connector 100a includes an insulative housing 1, a plurality of terminals 2 disposed in the insulative housing 1 and arranged along a longitudinal direction perpendicular to a X direction, a shell 3 covering an outside of the insulative housing 1 and a grounding plate 4 sandwiched between the shell 3 and the cable unit 100b. The cable unit 100b has a plurality of cables 5 assembled together.

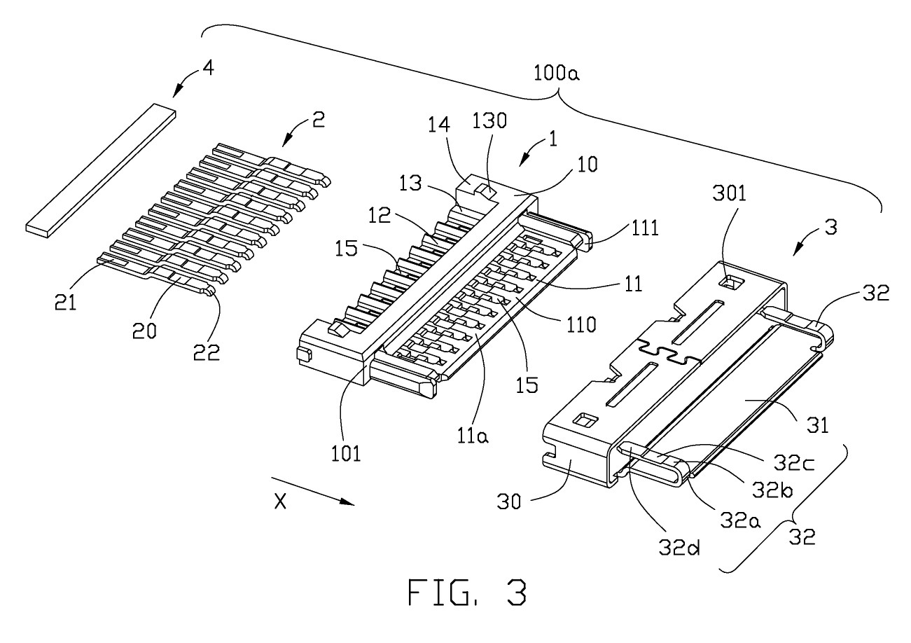

Referring to FIG. 3, the insulative housing 1 includes a longitudinal base portion 10 and an engaging portion 11 extending and protruding from a front edge 101 of the base portion 10 forward along a mating direction, i.e. the X direction. The base portion 10 defines a recess 12 at a rear side thereof for receiving the grounding plate 4 and the cable unit 100b therein. The recess 12 is surrounded by a bottom wall 13 and a pair of blocking walls 14 integrally connecting with both sides of the bottom wall 13. Furthermore, the bottom wall 13 has a plurality of receiving grooves 15 running through the base portion 10 and extending to the engaging portion 11. The engaging portion 11 includes a contacting area 110 and a pair of guiding portions 111 extending from both sides of the contacting area 110.

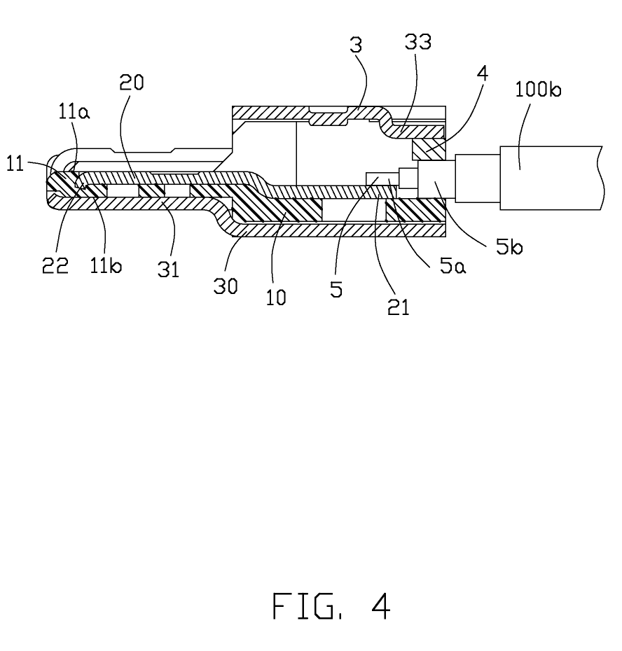

Referring to FIGS. 3 and 4, the terminals 2 are retained in the insulative housing 1 in an inert molding manner. Each of the terminals 2 includes a contacting portion 20 extending forward and disposed on upper side 11a (i.e. a second side) of the engaging portion 11 approximately from a middle area thereof, and a soldering portion 21 extending rearward for soldering to a first conductor portion 5a of the cable 5. Furthermore, the contacting portion 20 has a positioning tail 22 embedded into the engaging portion 11 for preventing the contacting portion 20 from being deformed outwards and overly inserted forward.

The shell 3 includes a body portion 30 covering the base portion 10 of the insulative housing 1, a connecting portion 31 integrally extending from the body portion 30 forward and covering a bottom side 11b (i.e. a first side) opposite to the upper side 11a of the engaging portion 11 for improving a strength of the shell 3, and a pair of forniciform-shaped grounding arms 32 which integrally connects with both ends of the connecting portion 31 at the longitudinal direction. The grounding plate 4 is sandwiched between the cable 5 and grounding tails 33 at rear edge of the shell 3. The cable 5 has a second conductor portion 5b connecting with the grounding plate 4 and being separated from the first conductor portion 5a by an insulative partition.

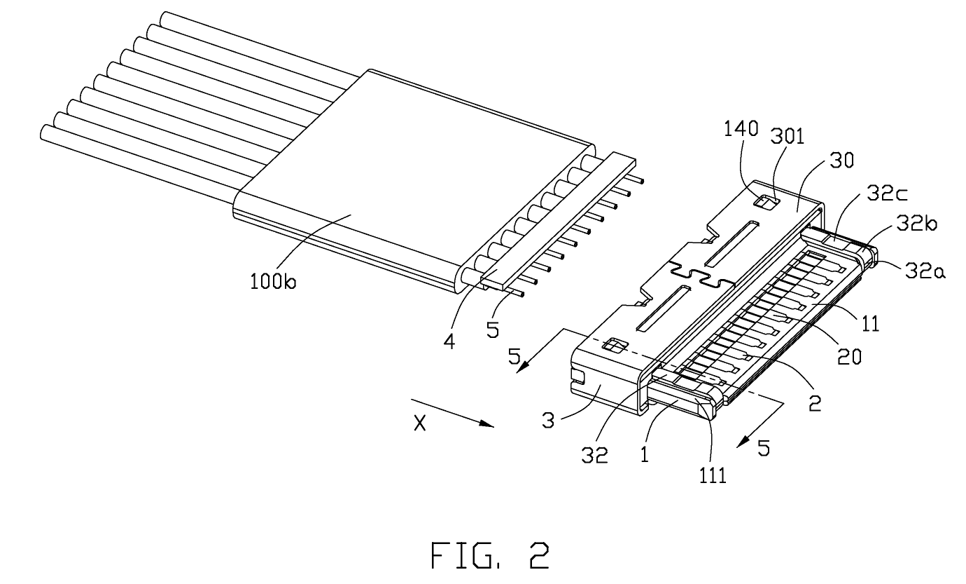

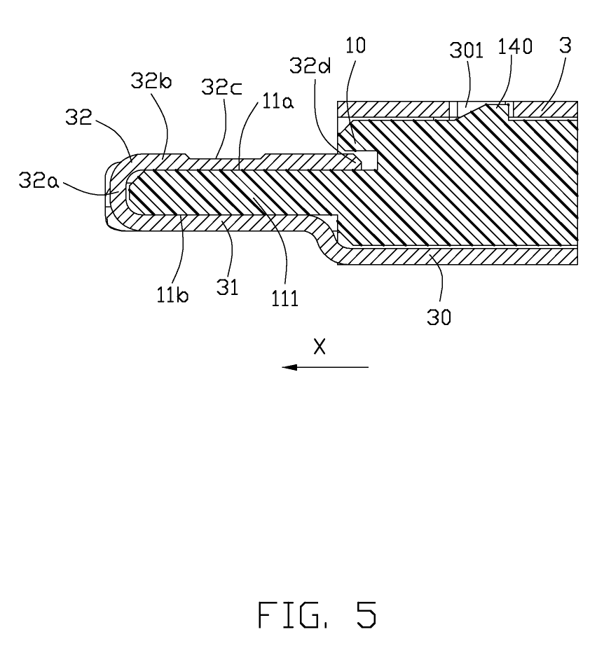

Referring to FIGS. 2, 3 and 5, the grounding arms 32 are correspondingly disposed in the guiding portion 111 at both sides of the engaging portion 11. Each of the grounding arms 32 integrally extends from the first side 11b of the engaging portion 11 forwardly and is continually folded backwards to the upper side 11a. The grounding arms 32 defines a U-shaped bridge portion 32a connecting with the connecting portion 31 and surrounding a front edge of the engaging portion 11, a contacting arm 32b extending backwards to the upper side 11a of the engaging portion 11 towards the base portion 10, a concaved portion 32c located at the contacting arm 32b and a free end 32d received and positioned in the base portion 10 of the insulative housing 1 for making the grounding arm 32 being steadily attached to the engaging portion 11. So the connecting portion 31 and the grounding arms 32 forms a U-shaped grounding device viewed from a side view along the longitudinal direction. Additionally, the base portion 10 forms a pair of blocking tubers 140 interfering with a locking opening 301 of the shell 3 for positioning the shell on the insulative housing 1.

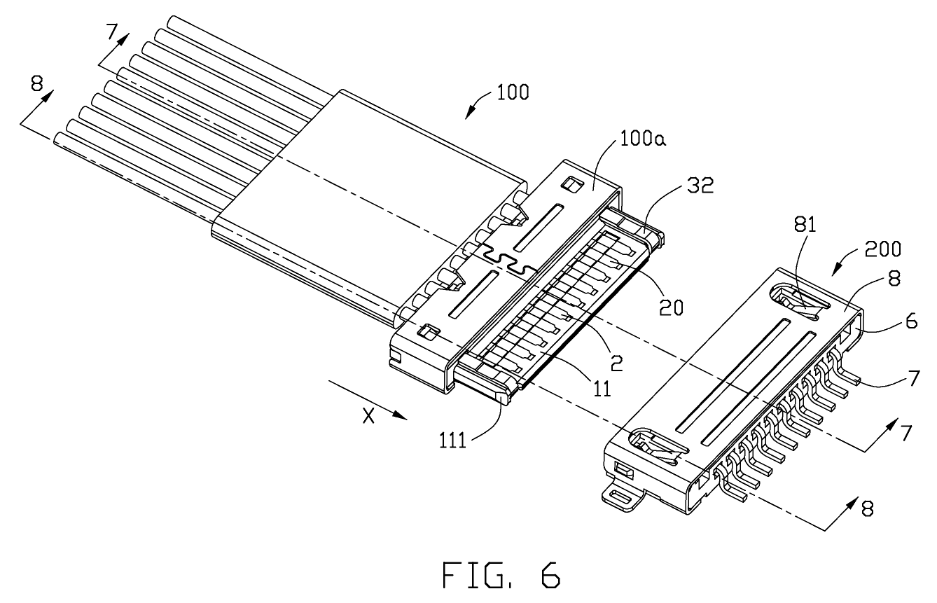

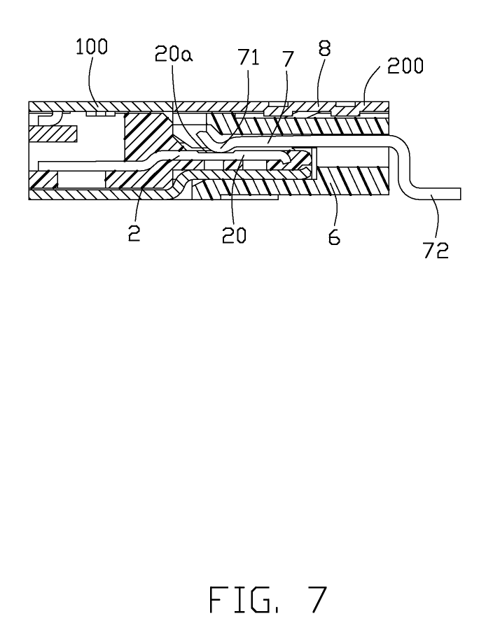

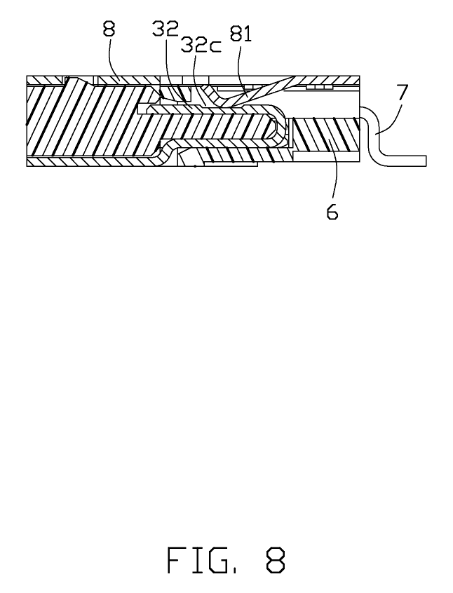

Referring to FIGS. 6 to 8, a mating connector 200 for electrically mating with the electrical connector assembly 100 includes a mating housing 6, a plurality of mating terminal 7 retained in the mating housing 6 and a mating shell 8 covering the mating housing 6. Because the grounding arms 32 are located former than the contacting portions 20 of the terminals 2 at the X direction, when the mating connector 200 is guided by the guiding portion 111 of the electrical connector 100a and engages with each other, the grounding arms 32 electrically pre-connect with a pair of mating grounding arms 81 of the mating shell 8 before the terminals 2 electrically connect with the mating terminals 7. So the shell 3, the mating shell 8, the grounding plate 4 and the cable 5 forms a grounding trace and preventing the connectors from EMI. The fold-back grounding arms 32 of the electrical connector 100a surround the front edge of the engaging portion 11, in such a manner that it could protect the grounding arm 32 from being broken by an impulsive force of mating connector 200 in the mating process. Furthermore, the mating grounding arms 81 could be locked in the concaved portion 32c of the grounding arm 32. The mating terminal 7 includes a forniciform contacting portion 71 for electrically connecting with the terminal 2, a terminal section 72 for soldering onto a PCB (not shown). The contacting portion 20 of the terminal 2 defines a recessing portion 20a for locking with the forniciform contacting portion 71.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector, comprising:
an insulative housing comprising a base portion and an engaging portion extending from the base portion;
a plurality of terminals disposed in the housing and comprising a contacting portion arranged on the engaging portion;
a shell covering an outside of the insulative housing; and
wherein the shell comprises at least one forniciform-shaped grounding arm, which integrally extends from a first side of the engaging portion forwardly and is continually folded backwards to a second side of the engaging portion opposite to the first side.

2. The electrical connector as described in claim 1, wherein a free end of the grounding arm is received in the base portion of the insulative housing, thereby the grounding arm is attached to the engaging portion.

3. The electrical connector as described in claim 2, wherein the grounding arm is located at outside of the terminals at a longitudinal direction in which the terminals are arranged.

4. The electrical connector as described in claim 3, wherein the grounding arm is located former than the contacting portions of the terminals at a mating direction perpendicular to the longitudinal direction.

5. The electrical connector as described in claim 4, wherein the engaging portion comprises a pair of guiding portions each corresponding to the grounding arms.

6. The electrical connector as described in claim 2, wherein the grounding arm comprises a concaved portion which is located at the second side of the engaging portion on which the contacting portions of the terminals are disposed.

7. The electrical connector as described in claim 6, wherein the shell comprises a connecting portion integrally connecting with the both grounding arms and covering the first side of the engaging portion.

8. The electrical connector as described in claim 7, wherein the contacting portion of the terminal defines a recessing portion.

9. An interconnecting system, comprising:
an electrical connector, comprising an insulative housing with an engaging portion extending from a longitudinal base portion thereof, a plurality of terminals disposed in the insulative housing with a contacting portion arranged on the engaging portion, and a shell covering the insulative housing;
a mating connector; and
wherein the shell comprises a U-shaped grounding device which is disposed at both side of the engaging portion and surrounds a front edge of the engaging portion and located former than the contacting portions of the terminals for pre-connecting with the mating connector electrically.

10. The interconnecting system as recited in claim 9, wherein a free end of the grounding device is received in the base portion.

11. The interconnecting system as recited in claim 10, wherein the shell comprise a body portion covering the base portion of the insulative housing and grounding device integrally connects with the body portion.

12. The interconnecting system as recited in claim 11, wherein the grounding device comprises a connecting portion covering a first side of the engaging portion and a pair of fold-back grounding arms extending from the connecting portion to a second side of the engaging portion opposite to the first side.

13. The interconnecting system as recited in claim 11, wherein the mating connector comprises a pair of mating grounding arms electrically connecting with the grounding arm of the electrical connector.

14. An electrical cable connector for use with a complementary connector, comprising:
an insulative housing defining a base portion and a mating tongue forwardly extending from the base portion with opposite first and second faces thereon;
a plurality of contacts disposed in the housing with contacting sections exposed upon the first face;
a plurality of cables located behind the housing and connected to the corresponding contacts, respectively;
a pair of guiding portions located by two sides of the mating tongue; and wherein
a metallic shell including a body portion circumferentially enclosing the base portion, a connecting portion forwardly extending from a front edge of the body portion and covering the second face, and a pair of grounding arms each extending backwardly from a front edge of the connecting portion in alignment with the corresponding guiding portion in a front-to-back direction.

15. The electrical cable connector as claimed in claim 14, wherein each of said grounding arms extends in said front-to-back direction with a distance essentially equal to a dimension of said mating tongue in said front-to-back direction.

16. The electrical cable connector as claimed in claim 14, wherein a distal free end of each of the grounding arms is inserted into the base portion.

17. The electrical cable connector as claimed in claim 14, wherein each of said grounding arms faces a same direction with the contacting sections while being located at a different level with regard to the first face.

18. The electrical cable connector as claimed in claim 14, wherein said grounding arm defines concaved portion for receiving an apex of a mating grounding arm of the complementary connector for both grounding and retention therebetween.

19. The electrical cable connector as claimed in claim 14, wherein said body portion includes a plurality of grounding tails downwardly pressing against a grounding bar which is spaced fro the contacts while mechanically and electrically connects to braiding of the cables.
